(19) United States
(12) Patent Application Publication
(10) Pub. No.: US 2010/0296869 A1
(43) Pub. Date: Nov. 25, 2010

(54) POWERED CONSTRUCTION GROUND COMPACTOR AND METHOD OF MAKING

(76) Inventors: David M. Catanzarite, Edinboro, PA (US); Keith R. Ptak, Erie, PA (US)

Correspondence Address: LORD CORPORATION;PATENT & LEGAL SERVICES, 111 LORD DRIVE, P.O. Box 8012, CARY, NC, 27512-8012, US

(21) Appl. No.: 12/863,907

(22) PCT Filed: Jan. 26, 2009
(86) PCT No.: PCT/US09/31954

§ 371 Date: Jul. 21, 2010

Related U.S. Application Data
(60) Provisional application No. 61/023,304, filed on Jan. 24, 2008.

(51) Int. Cl. E01C 19/32; B23P 11/00

(52) U.S. Cl. 404/133.1; 29/428

(57) ABSTRACT

A powered construction ground compactor for use by a worker compacting a construction foundation material. The powered construction ground compactor includes a lower foundation interfacer for interfacer engaging the construction foundation to be compacted, a powered compacting large moving mass, the powered compacting large moving mass forcing the foundation interfacer into construction foundation material to be compacted, an upper handle for holding by the worker compacting the construction foundation material, a handle moving mass vibration absorber, the handle moving mass vibration absorber including a moving mass, the moving mass movingly coupled to the upper handle wherein the moving mass oscillates relative to said compacting moving mass.

### CROSS REFERENCE

This application claims the benefit of, and incorporates by reference, U.S. Provisional Patent Application No. 61/023,304 filed on Jan. 24, 2008.

### FIELD OF INVENTION

The present invention relates to a powered construction ground compactors for use by a construction worker compacting construction materials and methods of making such powered construction ground compactors. More particularly the invention relates to powered moving mass construction ground compactor for compacting construction materials and foundations such as the ground, particularly the invention relates to compactors and methods of makings compactors held onto by and operated by an upright construction worker operator such as when operating rammer and jumping jack tamp compactors when compacting the ground, soils, backfill and other construction materials around and for structures and foundations and where construction compaction is required in building, civil, and road construction.

### SUMMARY OF THE INVENTION

In an embodiment the invention includes a powered construction ground compactor for use by a construction worker compacting a construction foundation, such as a ground, earth, dirt, rock, gravel, aggregate, and/or construction material that requires compacting. Preferably the powered construction ground compactor includes a lower foundation interfacer, the lower foundation interfacer engaging the construction foundation to be compacted. Preferably the powered construction ground compactor includes a powered compacting large moving mass, the powered compacting large moving mass forcing the foundation interfacer into the construction foundation to be compacted. Preferably the powered construction ground compactor includes an upper handle for holding by the worker compacting the construction foundation. Preferably the powered construction ground compactor includes a handle moving mass vibration absorber, the handle moving mass vibration absorber including a moving mass, the moving mass movingly coupled to the handle wherein the moving mass oscillates relative to the compacting moving mass.

In an embodiment the invention includes a powered construction compactor for use by a worker compacting a construction ground material. Preferably the powered construction compactor includes a lower interfacer shoe, the lower interfacer shoe engaging the construction material to be compacted. Preferably the powered construction compactor includes a powered compacting large moving mass, the large moving mass having a mass M1, the powered compacting large moving mass forcing the interfacer into the construction material to be compacted. Preferably the powered construction compactor includes a handle for holding by the worker compacting the construction material. Preferably the powered construction compactor includes a handle moving mass vibration absorber, the handle moving mass vibration absorber including a small moving mass, the small moving mass having a mass m2, with m2<M1. The small moving mass is movingly coupled proximate the handle wherein the small moving mass oscillates relative to the compacting large moving mass. Preferably the moving mass vibration absorber moving mass has a center of rotation and a center of mass with the center of mass offset from the center of rotation, the moving mass oscillating relative to the compacting moving mass with the moving mass vibration absorber center of mass rotating about the center of rotation.

In an embodiment the invention includes a powered compactor for use by a worker compacting a material, the powered compactor comprised of a lower foundation material interfacer, the lower foundation material interfacer engaging the construction foundation material to be compacted. Preferably the powered compactor includes a powered compacting large moving mass, the large moving mass having a mass M1, the powered compacting large moving mass forcing the material interfacer into the material to be compacted. Preferably the powered compactor includes a handle for holding by the worker compacting the material. The powered compactor includes a handle moving mass vibration absorber, the handle moving mass vibration absorber including at least a first small rotating mass, the at least first small moving mass having a mass m2, with m2<M1. The small moving mass has a center of rotation and a center of mass with the center of mass offset from the center of rotation, with the small moving mass oscillating relative to the compacting moving mass with the first small rotating mass center of mass rotating about the center of rotation.

In an embodiment the invention includes a powered compactor for use by a construction worker compacting a construction material. The powered compactor preferably includes a lower material interfacer, the lower material interfacer engaging the material to be compacted. The powered compactor preferably includes a powered compacting large moving mass, the large moving mass having a mass M1, the powered compacting large moving mass forcing the material interfacer into the material to be compacted. The powered compactor preferably includes a handle for holding by the worker compacting the construction material. The powered compactor preferably includes a handle moving mass vibration absorber, the handle moving mass vibration absorber including a small moving mass, the small moving mass having a mass m2, with m2<M1, the small moving mass driven to oscillate relative to the compacting large moving mass.

In an embodiment the invention includes a powered compactor for use by a worker compacting a construction material, the powered compactor comprised of a lower foundation material interfacer, the lower material interfacer engaging the material to be compacted. The powered compactor preferably includes a powered compacting large moving mass, the large moving mass having a mass M1, the powered compacting large moving mass forcing the material interfacer into the material to be compacted. The powered compactor including a handle for holding by the worker compacting the material. The powered compactor including a handle moving mass vibration absorber, the handle moving mass vibration absorber including a sprung moving mass, the sprung moving mass coupled to the handle wherein the sprung moving mass oscillates relative to the compacting large moving mass.

In an embodiment the invention includes a method of making a powered construction ground compactor for use by a construction worker compacting a ground construction material. The method preferably includes providing a powered construction ground compactor comprised of a lower material interfacer, the lower material interfacer engaging the construction material to be compacted, a powered compacting large moving mass, the powered compacting large moving mass for forcing the foundation interfacer into the construction material to be compacted, and a handle for holding by the worker compacting the construction material. The method includes coupling a moving mass vibration absorber small moving mass to the handle wherein the small moving mass oscillates relative to the compacting large moving mass.

In an embodiment the invention includes a method of making a powered construction ground compactor for use by a worker compacting a construction material. The method preferably includes providing a powered construction compactor comprised of a lower material interfacer shoe, the lower material interfacer engaging the construction material to be compacted, a powered compacting large moving mass with a mass M1, the powered compacting large moving mass M1 for forcing the interfacer shoe into the construction material to be compacted, and an handle for holding by the worker compacting the material. The method includes providing a vibration absorber small moving mass, the small moving mass having a mass m2 with m2<M1, and coupling the vibration absorber small moving mass proximate the handle wherein the small moving mass oscillates relative to the compacting large moving mass.

In preferred embodiments the compactor is comprised of a rammer jumping jack tamp compactors with the compactor held onto by (preferably with a handle) and operated by an upright construction worker operator such as when operating the rammer and jumping jack tamp compactors with the compactor powered moving mass and interfacer biased to provide a travel speed with the interfacer jumping the compactor upward and forward in such travel speed motion.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIG. 1A illustrates a powered construction ground compactor.

FIG. 1B illustrates a powered construction rammer jumping jack tamp compactor.

FIG. 1C illustrates a powered construction ground compactor with a cut away showing a powered large moving mass M1 inside the compactor powered by a power source.

FIG. 2A illustrates a powered construction ground compactor with a handle moving mass vibration absorber small moving mass m2.

FIG. 2B illustrates a powered construction ground compactor a cut away showing a powered large moving mass M1 with a mechanical coupling drive shaft lead driving small moving masses m2.

FIG. 2C illustrates a powered construction ground compactor large moving mass M1 mechanically coupled out of phase and driving a small moving masses m2 of a vibration canceling device (VCD) with a crankshaft and flexible driveshaft coupling lead linkage.

FIG. 2D is plot illustrating the small moving masses m2 phased vibration from the VCD linkage shown in FIG. 2C out of phase with the troublesome vibration from the compactor.

FIG. 3A illustrates a powered construction ground compactor handle moving mass vibration absorber small moving mass m2 attached to a compactor handle with a bracket with adjustable orientation with the moving mass m2 center of mass rotating around a center of rotation of the bracket.

FIG. 3B illustrates the assembly of the components utilized in FIG. 3A and the method of making the powered construction ground compactor handle moving mass vibration absorber small moving mass m2 attached to the compactor handle assembled from the components.

FIG. 4 illustrates a powered construction ground compactor moving mass vibration absorber with a first small moving mass m2 and a second counter rotating small moving mass m2 with a lead and gear linkage for driving the rotation of the counter rotating small moving masses.

FIG. 5A illustrates a powered construction ground compactor moving mass vibration absorber with a small moving mass m2 driven by a lead.

FIG. 5B illustrates a powered construction ground compactor moving mass vibration absorber with a small moving mass m2 driven by a lead connected to a reciprocating power source (such as a motor power take off, compactor large moving mass M1, compactor shoe interfacer, or separate independent power source motor.

FIG. 6A illustrates a powered construction ground compactor moving mass vibration absorber with a sprung small moving mass m2, with first and second springs coupling the small moving mass m2 to the powered construction ground compactor.

FIG. 6B illustrates the assembly of the components utilized in FIG. 6A and the method of making the powered construction ground compactor handle moving mass vibration absorber small moving mass m2 attached to the compactor handle assembled from the components.

FIG. 6C illustrates movement of the powered construction ground compactor handle moving mass vibration absorber small moving mass m2 shown in FIG. 6A, with the elastomer spring body shearing as the small moving mass m2 oscillates, with the elastomer spring elastomer bonded to the nonelastomer rigid outboard mounting end connector and to the nonelastomer rigid inboard mounting end connector (elastomer bonded to rigid mount end connectors for coupling the mass m2 to the compactor).

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment the invention includes a powered construction ground compactor for use by a construction worker compacting a construction foundation, such as a ground, earth, dirt, rock, gravel, aggregate, and/or construction material that requires compacting. Preferably the powered construction ground compactor includes a lower foundation interfacer, the lower foundation interfacer engaging the construction foundation to be compacted. Preferably the powered construction ground compactor includes a powered compacting large moving mass, the powered compacting large moving mass forcing the foundation interfacer into the construction foundation to be compacted. Preferably the powered construction ground compactor includes a handle for holding by the worker compacting the construction foundation. Preferably the powered construction ground compactor includes a handle moving mass vibration absorber, the handle moving mass vibration absorber including a moving mass, the moving mass movingly coupled to the handle wherein the moving mass oscillates relative to the compacting moving mass.

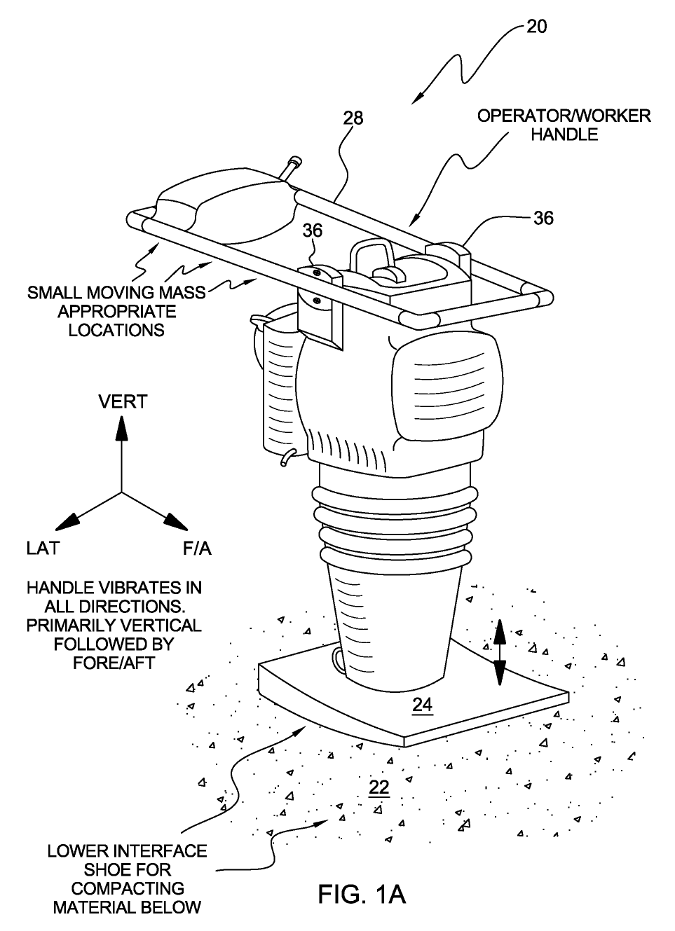

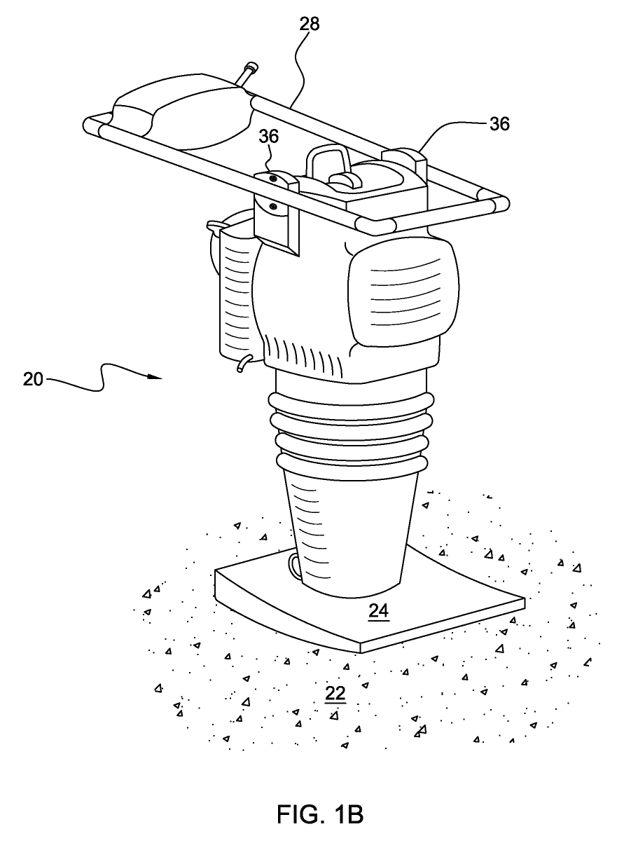

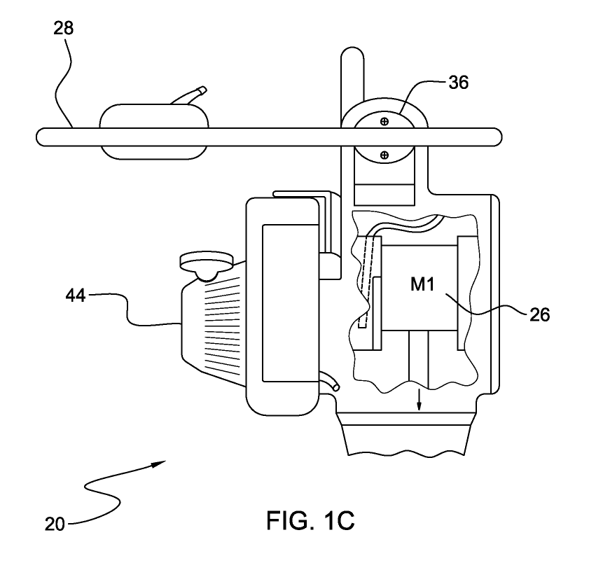

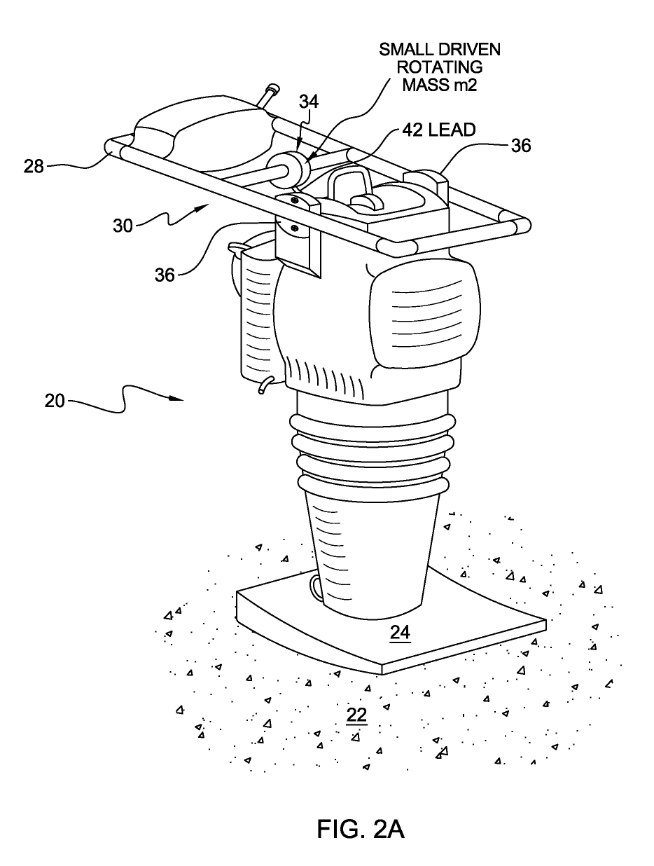

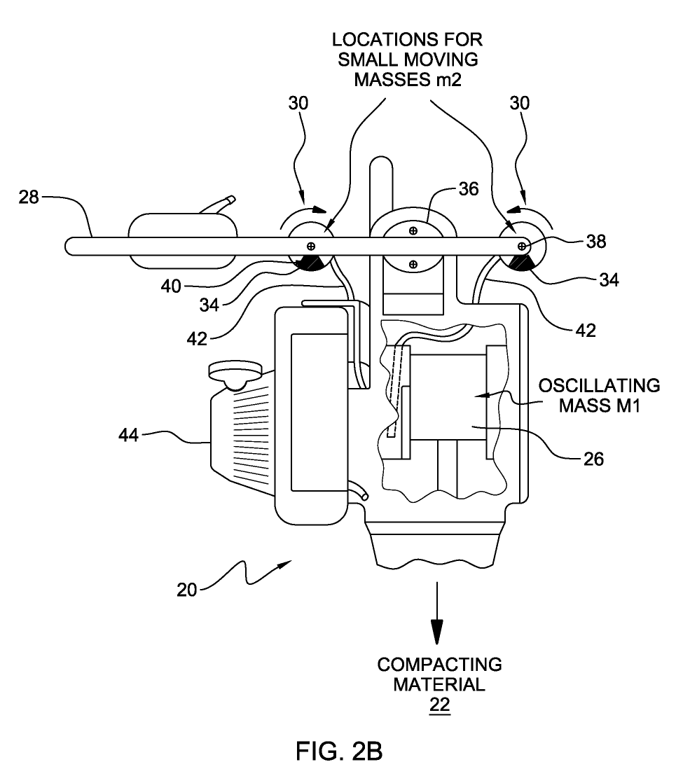

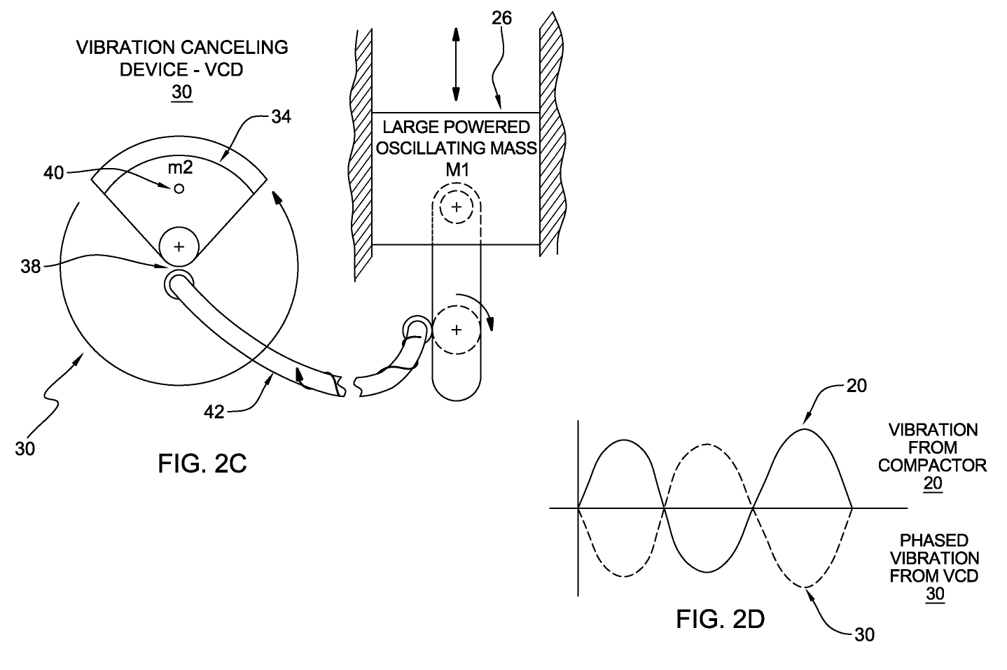

FIGS. 1 and 2 show powered construction ground compactors 20 for use by a construction worker compacting a construction foundation 22, such as a ground, earth, dirt, rock, gravel, aggregate, and/or construction material 22 that requires compacting. The powered construction ground compactors 20 include lower shoe interfacers 24, the lower interfacer 24 engaging the construction material 22 below to be compacted. The powered construction ground compactor 20 include powered compacting large moving masses 26, the powered compacting large moving mass 26 forcing the foundation interfacer 24 into the construction material 22 to be compacted and compacting the material. The powered construction ground compactors 20 include handles 28 for holding by the operator workers compacting the construction material below. Preferably the powered construction ground compactor 20 includes a handle moving mass vibration absorber 30, the handle moving mass vibration absorber 30 including a small moving mass 34, the small moving mass 34 movingly coupled to the handle 28 wherein the small moving mass 34 oscillates relative to the compacting moving mass 26.

In an embodiment the invention includes a powered construction ground compactor 20 for use by a construction worker compacting a construction foundation 22 such as a ground, earth, dirt, rock, gravel, aggregate, and/or construction material 22 below the compactor 20. The powered construction ground compactor 20 includes a lower foundation interfacer 24, the lower foundation interfacer 24 engaging the construction foundation 22 to be compacted. The powered construction ground compactor 20 includes a powered compacting large moving mass 26. The powered compacting large moving mass 26 preferably having a large moving mass=M1. The powered compacting large moving mass 26 forces the foundation interfacer 24 into the construction foundation 22 to be compacted. The powered construction ground compactor 20 includes an upper handle 28 for holding by the construction worker compacting the construction foundation 22, preferably with the handle 28 mounted with a pair of mounts 36 to an upper section of the compactor 20 distal from the foundation interfacer 24. The powered construction ground compactor 20 includes a handle moving mass vibration absorber 30, the handle moving mass vibration absorber 30 including a small moving mass 34, the small moving mass 34 movingly coupled to the upper handle 28 wherein the small moving mass 34 oscillates relative to the compacting large moving mass 26. Preferably the small moving mass has a mass m2 less than the powered compacting large moving mass M1. The handle moving mass resonates at a frequency to absorb vibration.

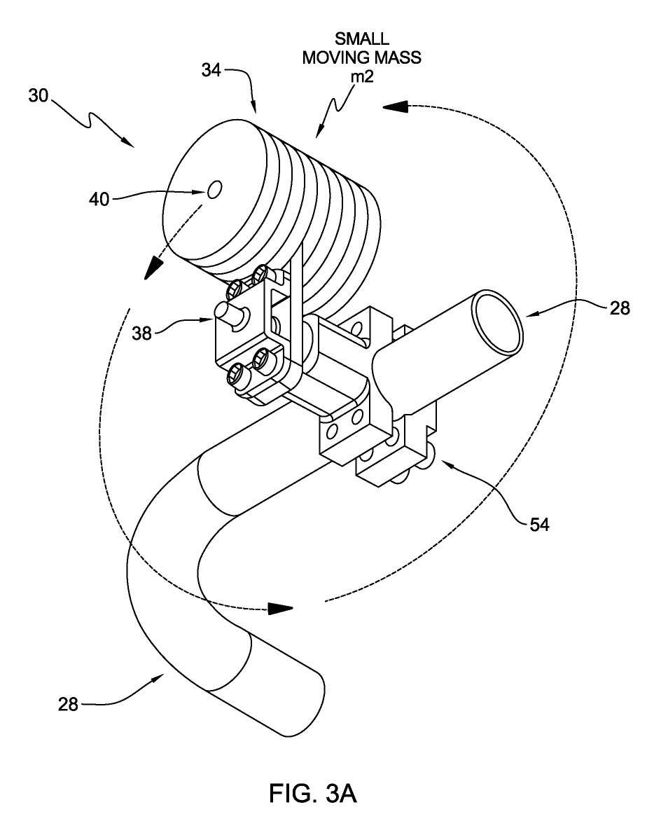

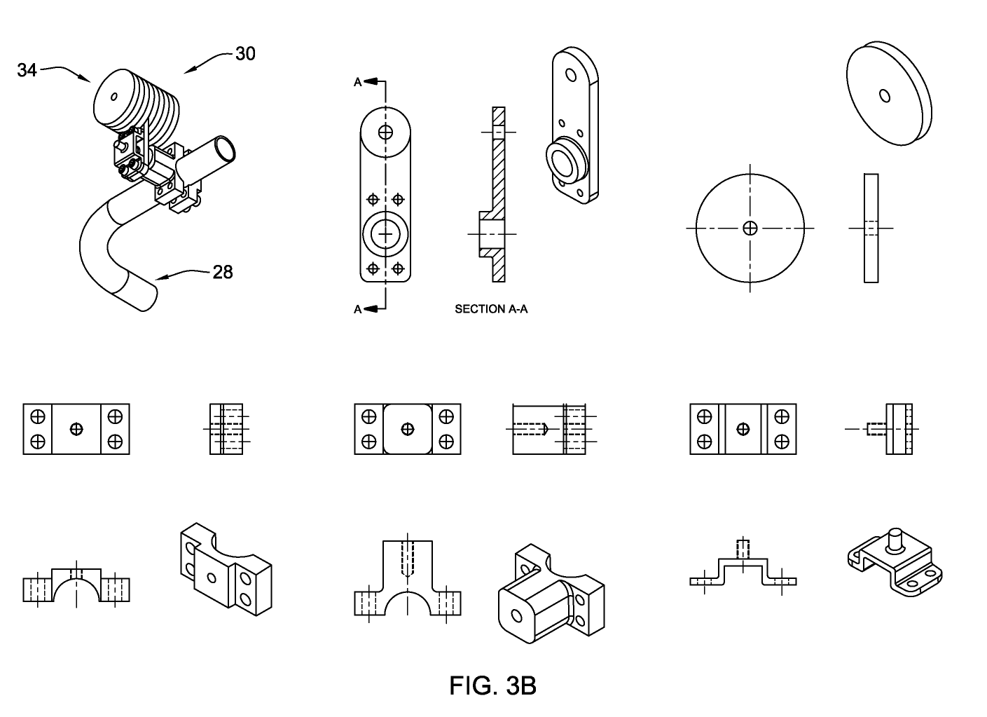

In embodiments the powered construction ground compactors 20 include a handle moving mass vibration absorber moving mass 34 with a center of rotation 38 and a center of mass 40. Preferably the center of mass 40 is offset from the center of rotation 38, with the moving mass oscillating relative to the compacting moving mass including the handle moving mass vibration absorber moving mass center of mass 40 rotating about the center of rotation 38. An embodiment is shown in FIG. 2 with the powered construction ground compactor 20 handle moving mass vibration absorber moving mass having a center of rotation 38 and a center of mass 40, with the center of mass 40 offset from the center of rotation 38, with the moving mass oscillating relative to the compacting moving mass, with the center of mass 40 rotating about the center of rotation 38. Preferably the rotation of the small moving mass m2 is driven in an out of phase relationship relative to the powered compacting large moving mass 26, preferably about 180 degrees out of phase. Another embodiment is shown in FIG. 3 with the powered construction ground compactor 20 handle moving mass vibration absorber moving mass having a center of rotation 38 and a center of mass 40, with the center of mass 40 offset from the center of rotation 38, with the moving mass oscillating relative to the compacting moving mass, with the center of mass 40 rotating about the center of rotation 38, with the rotation driven similar to FIG. 2. In additional embodiments the moving mass m2 is driven through the lead 42, with the distal end of the lead 42 coupling with the motion of the powered large moving mass M1, the motion of the power source 44 powering the large moving mass 26, or an additional source such as an electric motor. In additional embodiments the moving mass m2 is driven directly by an additional source such as a motor, such as an electric motor.

In embodiments the small moving mass m2 is an adjustable mass m2 comprised of discrete modules, such that mass m2 is adjustable, such a plurality of mass units, preferably comprised at least of two dissimilar materials with different densities, such as steel metal and plastic, but preferably of same size and dimension. In FIG. 3 are shown small moving mass modular mass units in the form of disks that are secured proximate the center of mass 40 to rotate about the center of rotation 38.

In embodiments the small moving mass m2 orientation relative to the handle 28 and the lower interfacer 24 is adjustable. In FIG. 3 the vibration absorber moving mass attachment bracket 54 is adjustable with the orientation of the small moving mass m2 adjustable, with the handle 28 received between the outer sandwiching members of attachment bracket 54.

In embodiments the powered construction ground compactor 20 includes a handle moving mass vibration absorber moving mass power lead 42, the lead 42 delivering power to rotate the handle moving mass vibration absorber moving mass center of rotation 38 rotating about the center of rotation 38.

In embodiments the powered construction ground compactor 20 includes a handle moving mass vibration absorber moving mass timing lead 42, the lead 42 timing rotation of the handle moving mass vibration absorber moving mass center of rotation rotating about the center of rotation 38 in relation to the powered compacting large moving mass 26, preferably out of phase.

In embodiments the powered construction ground compactor 20 includes a handle moving mass vibration absorber moving mass mechanical lead 42, the mechanical lead 42 coupling the handle moving mass vibration absorber moving mass with the powered compacting large moving mass 26, preferably powering rotation and timing the rotation.

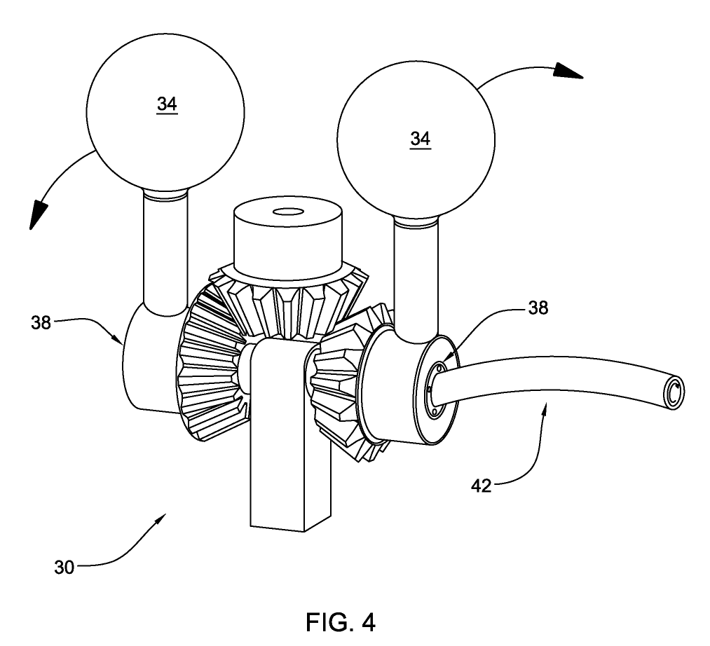

FIG. 4 shows an embodiment with a first small moving mass m2 clockwise rotating and a second small moving mass m2 counterclockwise rotating.

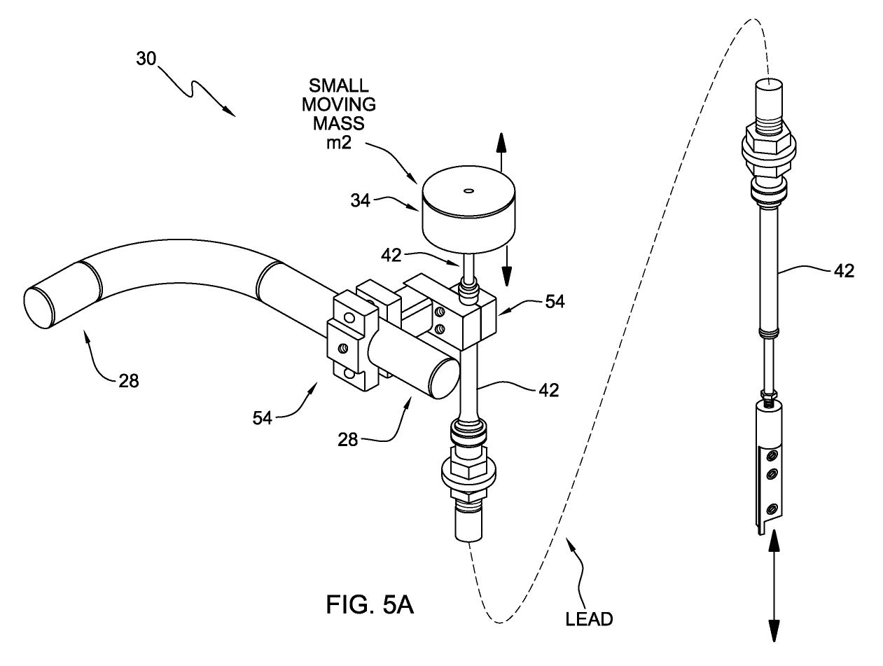

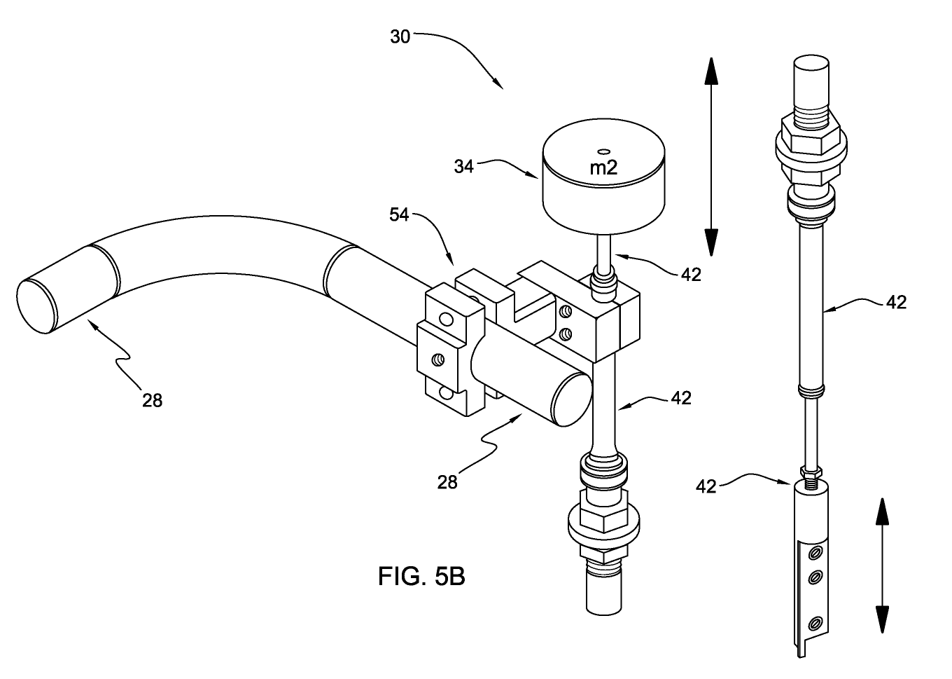

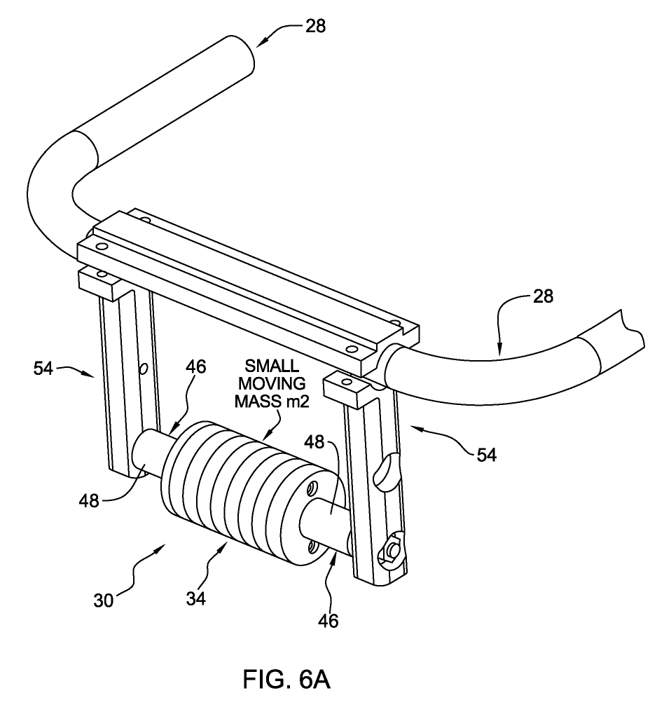

FIG. 5 shows an embodiment with small moving mass 34 linearly reciprocating. The moving mass m2 is driven to reciprocate through the lead 42.

In embodiments the powered construction ground compactor 20 includes a handle moving mass vibration absorber moving mass power lead 42, the lead 42 delivering power to oscillate the handle moving mass vibration absorber moving mass m2.

In embodiments the powered construction ground compactor 20 includes a handle moving mass vibration absorber moving mass timing lead 42, the lead 42 timing oscillation phases of the handle moving mass vibration absorber 30 in relation to the powered compacting large moving mass M1, preferably out of phase.

In embodiments the powered construction ground compactor 20 includes a handle moving mass vibration absorber moving mass mechanical lead 42, the mechanical lead 42 coupling the handle moving mass vibration absorber moving mass m2 with the powered compacting large moving mass M1 wherein the mechanical lead 42 provides power to urge the motion of the handle moving mass vibration absorber moving mass and timing to phase the motion of the handle moving mass vibration absorber moving mass out of phase with the powered compacting large moving mass 26. In embodiments the mechanical lead 42 is connected with a mechanical power take off, preferably from the power source moving the mass M1 or the moving mass M1 itself. Preferably the lead 42 is coupled with the power take off motor/engine powering the moving mass M1.

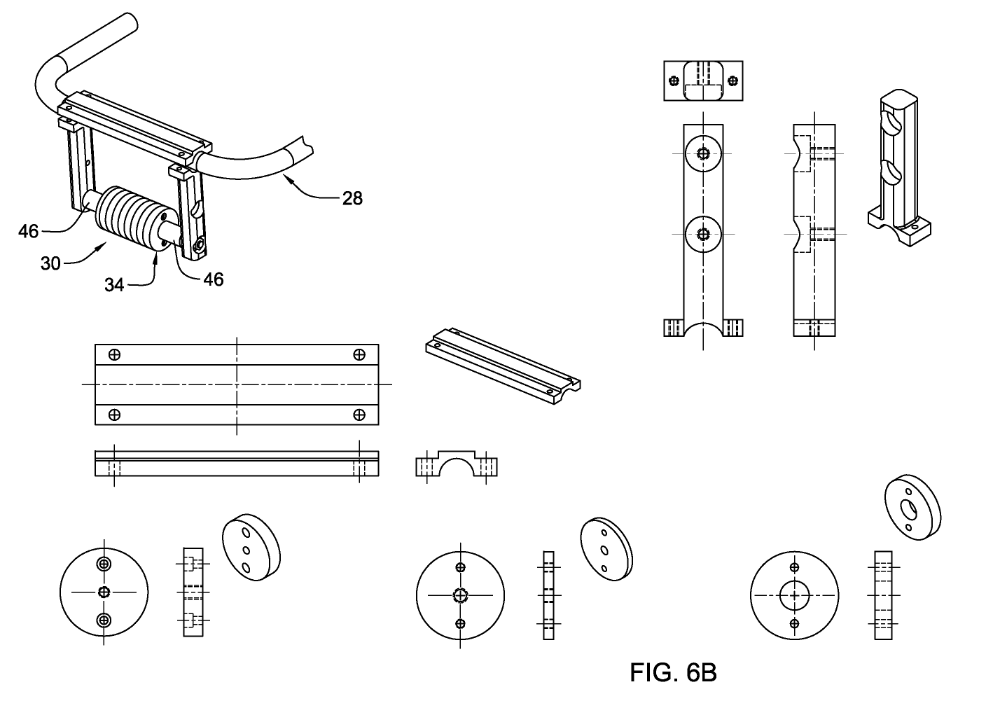

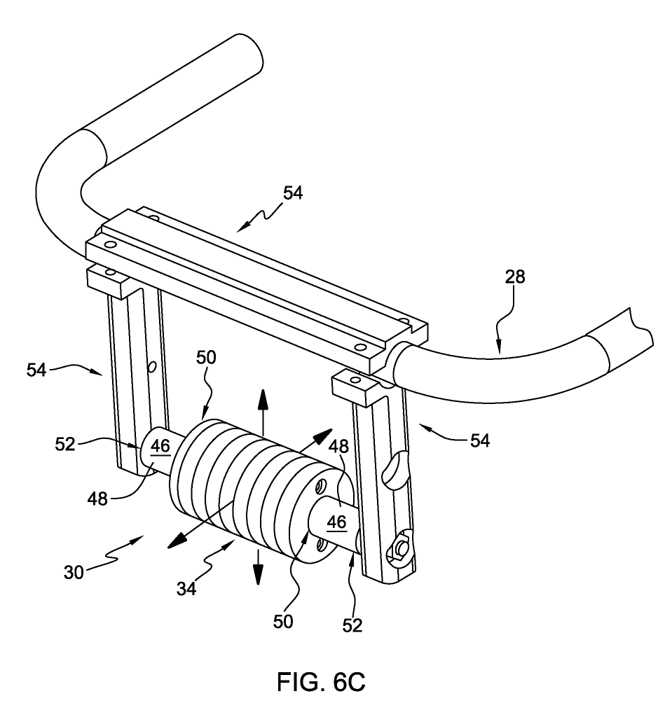

In embodiments the powered construction ground compactor 20 handle moving mass tuned vibration absorber moving mass is coupled with at least a first spring 46. Preferably the moving mass m2 is suspended between a first and second spring 46. Preferably the sprung moving mass has natural frequency tuned to resonate and absorb/minimize vibration from the large moving mass M1. Preferably the handle moving mass tuned vibration absorber moving mass is coupled with at least an elastomer 48. Preferably mass m2 is suspended between a first and second elastomer 48. As shown in FIG. 6, preferably the elastomer 48 is comprised of elastomeric body bonded on first side to first inboard nonelastomer mount connector 50 and second outboard nonelastomer mount connector 52, with elastomer shearing between mount connectors as the moving mass m2 oscillates. Preferably the handle small moving mass 34 is modular and made of discrete modules, such that mass is adjustable, such a plurality of mass units, preferably at least of two dissimilar materials with different densities, such as steel metal and plastic, but preferably of same size and dimension, such as the disk weights shown in FIGS. 6 and 3.

In an embodiment the powered construction ground compactor 20 for use by a construction worker compacting a construction material foundation 22 includes the lower foundation interfacer 24, the lower foundation interfacer 24 engaging the construction foundation 22 to be compacted, the powered compacting large moving mass 26, the large moving mass 26 having a mass M1, the powered compacting large moving mass 26 forcing the foundation interfacer 24 into the construction foundation 22 to be compacted, and the upper handle 28 for holding by the construction worker compacting the construction foundation 22. The powered construction ground compactor 20 includes a handle moving mass vibration absorber 30, the handle moving mass vibration absorber 30 including a small moving mass 34, the small moving mass 34 having a mass m2, with m2<M1, the small moving mass 34 movingly coupled to the upper handle 28 wherein the small moving mass 34 oscillates relative to the compacting large moving mass 26, the handle moving mass vibration absorber moving mass having a center of rotation 38 and a center of mass 40 with the center of mass 40 offset from the center of rotation 38, the moving mass oscillating relative to the compacting moving mass with the handle moving mass vibration absorber moving mass center of mass 40 rotating about the center of rotation 38.

In an embodiment the invention includes a powered construction ground compactor 20 for use by a construction worker compacting a foundation material 22, the powered compactor 20 comprised of a lower material interfacer 24, the lower material interfacer 24 engaging the material 22 to be compacted, a powered compacting large moving mass 26, the large moving mass 26 having a mass M1, the powered compacting large moving mass 26 forcing the material interfacer 24 into the material to be compacted, an upper handle 28 for holding by the construction worker compacting the material, and a handle moving mass vibration absorber 30, the handle moving mass vibration absorber 30 including at least a first small rotating mass, the at least first small moving mass 34 having a mass m2, with m2<M1, the small moving mass 34 having a center of rotation 38 and a center of mass 40 with the center of mass 40 offset from the center of rotation 38, the small moving mass 34 oscillating relative to the compacting moving mass with the first small rotating mass center of mass 40 rotating about the center of rotation 38.

In an embodiment the invention includes a powered construction compactor 20 for use by a construction worker compacting a construction foundation material 22, the powered construction ground compactor 20 comprised of a lower material interfacer 24, the lower material interfacer 24 engaging the construction 22 material to be compacted, a powered compacting large moving mass 26, the large moving mass 26 having a mass M1, the powered compacting large moving mass 26 forcing the foundation material interfacer 24 into the construction foundation material 22 to be compacted, an upper handle 28 for holding by the construction worker compacting the construction foundation material 22, and a handle moving mass vibration absorber 30, the handle moving mass vibration absorber 30 including a small moving mass 34, the small moving mass 34 having a mass m2, with m2<M1, the small moving mass 34 driven to oscillate relative to the compacting large moving mass 26. Preferably the handle moving mass vibration absorber small moving mass 34 is driven out of phase with the compacting large moving mass 26 motion. Preferably the handle moving mass vibration absorber small moving mass 34 rotates. Preferably the handle moving mass vibration absorber small moving mass 34 reciprocates. In an embodiment the handle moving mass vibration absorber small moving mass 34 is preferably a linearly reciprocating mass.

In an embodiment the invention includes a powered construction ground compactor 20 for use by a construction worker compacting a construction material, the powered construction ground compactor 20 comprised of a lower material interfacer 24, the lower material interfacer 24 engaging the construction foundation material 22 to be compacted, a powered compacting large moving mass 26, the large moving mass 26 having a mass M1, the powered compacting large moving mass 26 forcing the foundation material interfacer 24 into the construction foundation material 22 to be compacted, an upper handle 28 for holding by the construction worker compacting the construction foundation material 22, and a handle moving mass vibration absorber 30, the handle moving mass vibration absorber 30 including a sprung moving mass, the sprung moving mass coupled to the handle 28 wherein the sprung moving mass oscillates relative to the compacting large moving mass 26. Preferably the sprung moving mass has a mass m2, with m2<M1. Preferably the sprung moving mass is coupled with at least a first spring 46. Preferably the mass m2 is suspended between a first and second spring 46. Preferably the sprung moving mass has a natural frequency tuned to resonate and absorb/minimize vibration from the large moving mass 26. Preferably the sprung moving mass is coupled with at least a first elastomer. Preferably the mass m2 is suspended between a first and second shearing elastomer, preferably the elastomer is comprised of an elastomeric body bonded on a first side to first inboard nonelastomer mount connector and second outboard nonelastomer mount connector, with elastomer shearing between mount connectors as moving mass oscillates. Preferably the handle small moving mass 34 is modular and made of discrete modules, such that mass is adjustable, such a plurality of mass units, preferably at least of two dissimilar materials with different densities, such as steel metal and plastic, but preferably of same size and dimension. Preferably the handle moving mass vibration absorber 30 is attached with the handle 28 with adjustable brackets 54 with the orientation of the mass m2 relative to the handle 28 and the lower interfacer 24 adjustable.

In an embodiment the invention includes a method of making a powered construction ground compactor 20 for use by a construction worker compacting a construction foundation material 22. The method includes providing a powered construction ground compactor 20 comprised of a lower foundation material interfacer 24, the lower material interfacer 24 engaging the construction material to be compacted, a powered compacting large moving mass 26, the powered compacting large moving mass 26 for forcing the foundation interfacer 24 into the construction material to be compacted, and an upper handle 28 for holding by the construction worker compacting the construction material. The method includes coupling a moving mass vibration absorber small moving mass 34 to the upper handle 28 wherein the small moving mass 34 oscillates relative to the compacting large moving mass 26. Preferably the small moving mass 34 has a mass m2, with m2<M1.

In an embodiment the handle moving mass vibration absorber moving mass has a center of rotation 38 and a center of mass 40 with the center of mass 40 offset from the center of rotation 38, the moving mass oscillating relative to the compacting moving mass including the handle moving mass vibration absorber moving mass center of mass 40 rotating about the center of rotation 38.

In an embodiment the method includes providing a handle moving mass vibration absorber moving mass power lead 42, the lead 42 delivering power to oscillate the handle moving mass vibration absorber moving mass.

In an embodiment the method includes providing a handle moving mass vibration absorber moving mass timing lead 42, the lead 42 timing oscillations of the handle moving mass vibration absorber 30 in relation to the powered compacting large moving mass 26, preferably out of phase.

In an embodiment the method includes providing a handle moving mass vibration absorber moving mass mechanical lead 42, the mechanical lead 42 coupling the handle moving mass vibration absorber moving mass with the powered compacting large moving mass 26, preferably powering the oscillation and timing the oscillation.

In an embodiment the method includes providing a handle moving mass vibration absorber moving mass power lead 42, the lead 42 delivering power to rotate the handle moving mass vibration absorber moving mass.

In an embodiment the method includes providing a handle moving mass vibration absorber moving mass timing lead 42, the lead 42 timing rotational phases of the handle moving mass vibration absorber 30 in relation to the powered compacting large moving mass 26, preferably out of phase.

In an embodiment the method includes providing a handle moving mass vibration absorber moving mass mechanical lead 42, the mechanical lead 42 coupling the handle moving mass vibration absorber moving mass with the powered compacting large moving mass 26 wherein the mechanical lead 42 provides power to urge the motion of the handle moving mass vibration absorber moving mass and timing to phase the motion of the handle moving mass vibration absorber moving mass out of phase with the powered compacting large moving mass 26, preferably the lead 42 is connected with a mechanical power take off, from the power source moving mass or the moving mass itself. Preferably the mechanical lead 42 couples the moving mass m2 with the power take off motor/engine powering moving mass.

In an embodiment the method includes coupling the handle moving mass vibration absorber moving mass with at least a first spring 46, preferably with the mass suspended between a first and second spring 46. Preferably the sprung moving mass m2 has a natural frequency tuned to resonate and absorb/minimize vibration from the large moving mass M1.

In an embodiment the method includes coupling the handle moving mass tuned vibration absorber moving mass with at least a first elastomer, preferably the mass m2 is suspended between a first and second elastomer. Preferably the elastomer is comprised of elastomeric body bonded on first side to first inboard nonelastomer mount connector and second outboard nonelastomer mount connector, with the elastomer shearing between mount connectors as the moving mass m2 oscillates.

In preferred embodiments the handle small moving mass 34 is modular and made of discrete modules, such that mass m2 is adjustable, such a plurality of mass units, preferably at least of two dissimilar materials with different densities, such as steel metal and plastic, but preferably of same size and dimension, such as disk units.

In an embodiment the moving mass vibration absorber moving mass is driven to linearly reciprocate.

The invention includes a method of making a powered construction ground compactor 20 for use by a construction worker compacting a construction material. The method includes providing a powered construction compactor 20 comprised of a lower material interfacer shoe 24, said lower material interfacer 24 engaging the construction material to be compacted, a powered compacting large moving mass 26 with a mass M1, said powered compacting large moving mass M1 for forcing said interfacer shoe 24 into said construction material to be compacted, and an handle 28 for holding by said worker compacting said material. The method includes providing a vibration absorber small moving mass 34, said small moving mass 34 having a mass m2 with m2<M1, and coupling the vibration absorber small moving mass 34 proximate the handle 28 wherein the small moving mass 34 oscillates relative to said compacting large moving mass 26.

In an embodiment the handle moving mass vibration absorber moving mass has a center of rotation 38 and a center of mass 40 with the center of mass 40 offset from the center of rotation 38, the moving mass oscillating relative to the compacting moving mass including the handle moving mass vibration absorber moving mass center of mass 40 rotating about the center of rotation.

In an embodiment the method includes providing a handle moving mass vibration absorber moving mass power lead 42, the lead 42 delivering power to oscillate the handle moving mass vibration absorber moving mass.

In an embodiment the method includes providing a handle moving mass vibration absorber moving mass timing lead 42, the lead 42 timing oscillations of the handle moving mass vibration absorber 30 in relation to the powered compacting large moving mass 26, preferably out of phase.

In an embodiment the method includes providing a handle moving mass vibration absorber moving mass mechanical lead 42, the mechanical lead 42 coupling the handle moving mass vibration absorber moving mass with the powered compacting large moving mass 26, preferably powering the oscillation and timing the oscillation.

In an embodiment the method includes providing a handle moving mass vibration absorber moving mass power lead 42, the lead 42 delivering power to rotate the handle moving mass vibration absorber moving mass.

In an embodiment the method includes providing a handle moving mass vibration absorber moving mass timing lead 42, the lead 42 timing rotational phases of the handle moving mass vibration absorber 30 in relation to the powered compacting large moving mass 26, preferably out of phase.

In an embodiment the method includes providing a handle moving mass vibration absorber moving mass mechanical lead 42, the mechanical lead 42 coupling the handle moving mass vibration absorber moving mass with the powered compacting large moving mass 26 wherein the mechanical lead 42 provides power to urge the motion of the handle moving mass vibration absorber moving mass and timing to phase the motion of the handle moving mass vibration absorber moving mass out of phase with the powered compacting large moving mass 26, preferably the lead 42 is connected with a mechanical power take off, from the power source moving mass or the moving mass itself. Preferably the mechanical lead 42 couples the moving mass m2 with the power take off motor/engine powering moving mass.

In an embodiment the method includes coupling the handle moving mass vibration absorber moving mass with at least a first spring 46, preferably with the mass suspended between a first and second spring 46. Preferably the sprung moving mass m2 has a natural frequency tuned to resonate and absorb/minimize vibration from the large moving mass M1.

In an embodiment the method includes coupling the handle moving mass tuned vibration absorber moving mass with at least a first elastomer, preferably the mass m2 is suspended between a first and second elastomer. Preferably the elastomer is comprised of elastomeric body bonded on first side to first inboard nonelastomer mount connector and second outboard nonelastomer mount connector, with the elastomer shearing between mount connectors as the moving mass m2 oscillates.

In preferred embodiments the handle small moving mass 34 is modular and made of discrete modules, such that mass m2 is adjustable, such a plurality of mass units, preferably at least of two dissimilar materials with different densities, such as steel metal and plastic, but preferably of same size and dimension, such as disk units.

In an embodiment the moving mass vibration absorber moving mass is driven to reciprocate.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

1. A powered construction ground compactor for use by a worker compacting a construction foundation,
said powered construction ground compactor comprised of:
a lower foundation interfacer, said lower foundation interfacer engaging the construction foundation to be compacted,
a powered compacting large moving mass, said powered compacting large moving mass forcing said foundation interfacer into said construction foundation to be compacted,
an upper handle for holding by said worker compacting said construction foundation,
a handle moving mass vibration absorber, said handle moving mass vibration absorber including a moving mass, said moving mass movingly coupled to said upper handle wherein said moving mass oscillates relative to said compacting moving mass.

2. A powered construction ground compactor as claimed in claim 1 wherein said handle moving mass vibration absorber moving mass has a center of rotation and a center of mass with said center of mass offset from said center of rotation, said moving mass oscillating relative to said compacting moving mass including said handle moving mass vibration absorber moving mass center of mass rotating about said center of rotation.

3. A powered construction ground compactor as claimed in claim 2, including a handle moving mass vibration absorber moving mass lead, said lead delivering power to rotate said handle moving mass vibration absorber moving mass center of rotation rotating about said center of rotation.

4. A powered construction ground compactor as claimed in claim 2, including a handle moving mass vibration absorber moving mass lead, said lead timing rotation of said handle moving mass vibration absorber moving mass center of rotation rotating about said center of rotation in relation to said powered compacting large moving mass.

5. A powered construction ground compactor as claimed in claim 2, including a handle moving mass vibration absorber moving mass mechanical lead, said mechanical lead coupling said handle moving mass vibration absorber moving mass with said powered compacting large moving mass.

6. A powered construction ground compactor as claimed in claim 1, including a handle moving mass vibration absorber moving mass lead, said lead delivering power to oscillate said handle moving mass vibration absorber moving mass.

7. A powered construction ground compactor as claimed in claim 1, including a handle moving mass vibration absorber moving mass lead, said lead timing oscillation phases of said handle moving mass vibration absorber in relation to said powered compacting large moving mass.

8. A powered construction ground compactor as claimed in claim 1, including a handle moving mass vibration absorber moving mass mechanical lead, said mechanical lead coupling said handle moving mass vibration absorber moving mass with said powered compacting large moving mass wherein said mechanical lead provides power to urge the motion of said handle moving mass vibration absorber moving mass and timing to phase the motion of said handle moving mass vibration absorber moving mass out of phase with said powered compacting large moving mass.

9. A powered construction ground compactor as claimed in claim 1 wherein said handle moving mass vibration absorber moving mass is coupled with at least a first spring.

10. A powered construction ground compactor as claimed in claim 6 wherein said handle moving mass vibration absorber moving mass is coupled with at least an elastomer.

11. A powered construction compactor for use by a worker compacting a construction material,
said powered construction compactor comprised of:
a lower foundation interfacer, said lower foundation interfacer engaging the construction material to be compacted,
a powered compacting large moving mass, said large moving mass having a mass M1, said powered compacting large moving mass forcing said foundation interfacer into said construction material to be compacted,
a handle for holding by said worker compacting said construction material,
a handle moving mass vibration absorber, said handle moving mass vibration absorber including a small moving mass, said small moving mass having a mass m2, with m2<M1,
said small moving mass movingly coupled to said upper handle wherein said small moving mass oscillates relative to said compacting large moving mass, said handle moving mass vibration absorber moving mass having a center of rotation and a center of mass with said center of mass offset from said center of rotation, said moving mass oscillating relative to said compacting moving mass with said handle moving mass vibration absorber moving mass center of mass rotating about said center of rotation.

12. A powered compactor for use by a worker compacting a construction material,
said powered compactor comprised of:
a lower material interfacer, said lower material interfacer engaging the material to be compacted,
a powered compacting large moving mass, said large moving mass having a mass M1, said powered compacting large moving mass forcing said material interfacer into said material to be compacted,
a handle for holding by said worker compacting said material,
a handle moving mass vibration absorber, said handle moving mass vibration absorber including at least a first small rotating mass, said at least first small moving mass having a mass m2, with m2<M1, said small moving mass having a center of rotation and a center of mass with said center of mass offset from said center of rotation, said small moving mass oscillating relative to said compacting moving mass with said first small rotating mass center of mass rotating about said center of rotation.

13. A powered compactor for use by a worker compacting a material,
said powered compactor comprised of:
a lower material interfacer, said lower material interfacer engaging the material to be compacted,
a powered compacting large moving mass, said large moving mass having a mass M1, said powered compacting large moving mass forcing said material interfacer into said material to be compacted,
a handle for holding by said worker compacting said material,
a handle moving mass vibration absorber, said handle moving mass vibration absorber including a small moving mass, said small moving mass having a mass m2, with m2<M1, said small moving mass driven to oscillate relative to said compacting large moving mass.

14. A powered compactor as claimed in claim 13 wherein said handle moving mass vibration absorber small moving mass is driven out of phase with said compacting large moving mass motion.

15. A powered compactor as claimed in claim 13 wherein said handle moving mass vibration absorber small moving mass rotates.

16. A powered compactor as claimed in claim 13 wherein said handle moving mass vibration absorber small moving mass reciprocates.

17. A powered compactor as claimed in claim 13 with a lead between said large moving mass and said small moving mass.

18. A powered compactor for use by a worker compacting a construction material,
said powered compactor comprised of:
a lower material interfacer, said lower material interfacer engaging the material to be compacted,
a powered compacting large moving mass, said large moving mass having a mass M1, said powered compacting large moving mass forcing said material interfacer into said material to be compacted,
a handle for holding by said worker compacting said material,
a handle moving mass vibration absorber, said handle moving mass vibration absorber including a sprung moving mass, said sprung moving mass coupled to said handle wherein said sprung moving mass oscillates relative to said compacting large moving mass.

19. A compactor as claimed in claim 18 wherein said sprung moving mass is coupled with at least a first spring.

20. A compactor as claimed in claim 18 wherein said sprung moving mass is coupled with at least a first elastomer.

21. A method of making a powered construction ground compactor for use by a worker compacting a construction material,
said method including:
providing a powered construction ground compactor comprised of a lower material interfacer, said lower material interfacer engaging the construction material to be compacted,
a powered compacting large moving mass, said powered compacting large moving mass for forcing said foundation interfacer into said construction material to be compacted, and a handle for holding by said worker compacting said construction material,
coupling a moving mass vibration absorber small moving mass to said handle wherein said small moving mass oscillates relative to said compacting large moving mass.

22. A method as claimed in claim 21 wherein said handle moving mass vibration absorber moving mass has a center of rotation and a center of mass with said center of mass offset from said center of rotation, said moving mass oscillating relative to said compacting moving mass including said handle moving mass vibration absorber moving mass center of mass rotating about said center of rotation.

23. A method as claimed in claim 21 including providing a handle moving mass vibration absorber moving mass lead, said lead delivering power to oscillate said handle moving mass vibration absorber moving mass.

24. A method as claimed in claim 21 including providing a handle moving mass vibration absorber moving mass lead, said lead timing oscillations of said handle moving mass vibration absorber in relation to said powered compacting large moving mass.

25. A method as claimed in claim 21 including providing a handle moving mass vibration absorber moving mass mechanical lead, said mechanical lead coupling said handle moving mass vibration absorber moving mass with said powered compacting large moving mass.

26. A method as claimed in claim 21 including providing a handle moving mass vibration absorber moving mass lead, said lead delivering power to rotate said handle moving mass vibration absorber moving mass.

27. A method as claimed in claim 21 including providing a handle moving mass vibration absorber moving mass lead, said lead timing rotational phases of said handle moving mass vibration absorber in relation to said powered compacting large moving mass.

28. A method as claimed in claim 21 including providing a handle moving mass vibration absorber moving mass mechanical lead, said mechanical lead coupling said handle moving mass vibration absorber moving mass with said powered compacting large moving mass wherein said mechanical lead provides power to urge the motion of said handle moving mass vibration absorber moving mass and timing to phase the motion of said handle moving mass vibration absorber moving mass out of phase with said powered compacting large moving mass.

29. A method as claimed in claim 21 including coupling said handle moving mass vibration absorber moving mass with at least a first spring.

30. A method as claimed in claim 21 including coupling said handle moving mass vibration absorber moving mass with at least a first elastomer.

31. A method as claimed in claim 21 wherein said moving mass vibration absorber moving mass is driven to linearly reciprocate.

32. A method of making a powered construction ground compactor for use by a worker compacting a construction material,
said method including:
providing a powered construction compactor comprised of a lower material interfacer shoe,
said lower material interfacer engaging the construction material to be compacted, a powered compacting large moving mass with a mass M1, said powered compacting large moving mass M1 for forcing said interfacer shoe into said construction material to be compacted, and an handle for holding by said worker compacting said material,
providing a vibration absorber small moving mass, said small moving mass having a mass m2 with m2<M1,
and coupling said vibration absorber small moving mass proximate said handle wherein said small moving mass oscillates relative to said compacting large moving mass.

33. A method as claimed in claim 32 wherein said handle moving mass vibration absorber moving mass has a center of rotation and a center of mass with said center of mass offset from said center of rotation, said moving mass oscillating relative to said compacting moving mass including said handle moving mass vibration absorber moving mass center of mass rotating about said center of rotation.

34. A method as claimed in claim 32 including providing a handle moving mass vibration absorber moving mass lead, said lead delivering power to oscillate said handle moving mass vibration absorber moving mass.

35. A method as claimed in claim 32 including providing a handle moving mass vibration absorber moving mass lead, said lead timing oscillations of said handle moving mass vibration absorber in relation to said powered compacting large moving mass.

36. A method as claimed in claim 32 including providing a handle moving mass vibration absorber moving mass mechanical lead, said mechanical lead coupling said handle moving mass vibration absorber moving mass with said powered compacting large moving mass.

37. A method as claimed in claim 32 including providing a handle moving mass vibration absorber moving mass lead, said lead delivering power to rotate said handle moving mass vibration absorber moving mass.

38. A method as claimed in claim 32 including providing a handle moving mass vibration absorber moving mass lead, said lead timing rotational phases of said handle moving mass vibration absorber in relation to said powered compacting large moving mass.

39. A method as claimed in claim 32 including providing a handle moving mass vibration absorber moving mass mechanical lead, said mechanical lead coupling said handle moving mass vibration absorber moving mass with said powered compacting large moving mass wherein said mechanical lead provides power to urge the motion of said handle moving mass vibration absorber moving mass and timing to phase the motion of said handle moving mass vibration absorber moving mass out of phase with said powered compacting large moving mass.

40. A method as claimed in claim 32 including coupling said handle moving mass vibration absorber moving mass with at least a first spring.

41. A method as claimed in claim 32 including coupling said handle moving mass vibration absorber moving mass with at least a first elastomer.

42. A method as claimed in claim 32 wherein said moving mass vibration absorber moving mass reciprocates.
